(19) United States
(12) Patent Application Publication
(10) Pub. No.: US 2026/0027857 A1
(43) Pub. Date: Jan. 29, 2026

(54) PNEUMATIC TYRE EQUIPPED WITH AN ELECTRONIC DEVICE

(71) Applicant: Bridgestone Europe NV/SA, Zaventem (BE)

(72) Inventors: Ciro Vecchione, Roma (IT); Giulio Arcangeli, Roma (IT); Marco Tomaselli, Roma (IT)

(21) Appl. No.: 18/997,143

(22) PCT Filed: Jul. 16, 2023
(86) PCT No.: PCT/EP2023/069740

§ 371 Date: Jan. 20, 2025

(30) Foreign Application Priority Data
Jul. 19, 2022 (IT) 102022000015150

(51) Int. Cl. B60C 19/00; B60C 5/14

(52) U.S. Cl. CPC B60C 19/00; B60C 5/14; B60C 2005/147; B60C 2019/004

(57) ABSTRACT

A pneumatic tire and method of production thereof are disclosed, wherein the tire comprises an innerliner, which constitutes an inner covering and has the purpose of holding air within the pneumatic tire. A joint of the innerliner confers a cylindrical shape to the innerliner. A radio frequency identification (RFID) label is applied to a radially inner surface of the innerliner which constitutes the innermost free surface of the pneumatic tire, and is completely arranged within a zone which is centered on the joint and which extends circumferentially starting with the joint for no more than 90° per side.

### TECHNICAL SECTOR

The present invention is advantageously applied to a pneumatic tire equipped with an RFID label, i.e., with an identification label based on RFID (“Radio Frequency IDentification”) technology, to which the discussion below will explicitly refer without thereby sacrificing general applicability.

### PRIOR ART

In recent years, so-called “smart” pneumatic tires have emerged, which are capable of forming an active part of modern vehicles, supplying information concerning the type of pneumatic tires mounted, information concerning the state of the pneumatic tires and also information concerning ambient conditions. A “smart” pneumatic tire is provided with an RFID (“Radio Frequency IDentification”) label, which permits remote communication of information such as the identification, the characteristics and the history of the pneumatic tire.

It has been proposed (for example, as described in the patent applications US2020070597A1, US20210016614A1 and EP4019241A2) to glue an RFID label onto the inner surface or onto the external surface of a sidewall of a pneumatic tire; this solution is extremely simple from a design perspective and is applicable also to existing pneumatic tires; however, by contrast, it does not guarantee that the transponder will not detach from the pneumatic tire (especially when it is glued to the external surface) following the cyclical deformations to which the sidewall of a pneumatic tire is subjected. It was also proposed (as described, for example, in the patent applications US20080289736A1, EP2186658A1 and EP1366931A2) to integrate a transponder into the structure of a pneumatic tire, i.e., within the various layers that make up the pneumatic tire.

The U.S. Pat. No. 7,556,074B2 describes a pneumatic tire having a cavity formed in its interior for receiving a removable electronic monitoring module.

The patent application EP3798020A1 describes a pneumatic tire (1) having an overlap region in which an inner layer of the pneumatic tire is overlapping.

Particularly in the case in which the RFID label is glued to the radially inner surface (made up of the innerliner) of a pneumatic tire, it was observed that with a non-indifferent frequency there may be ruptures (cracks) in the innerliner near the zone in which the RFID label was glued.

### DESCRIPTION OF THE INVENTION

The object of the present invention is to supply a pneumatic tire provided with an electronic device, this pneumatic tire being free of the drawbacks described above, i.e., not being subject to the risk of detachments or ruptures of the innerliner near the zone in which the electronic device was applied and, at the same time, being easy and economical to produce.

According to the present invention, a pneumatic tire equipped with an electronic device is provided as set forth in the appended claims.

The claims describe preferred embodiments of the present invention that form an integral part of the present description.

### BRIEF DESCRIPTION OF THE DRAWINGS

The present invention will now be described with reference to the attached drawings, which illustrate an exemplary, non-limiting embodiment, wherein:

FIG. 1 is a schematic cross-sectional view of a pneumatic tire provided with an RFID label;

FIGS. 2 and 3 are, respectively, a perspective view and a perspective exploded view of the RFID label of the pneumatic tire of FIG. 1;

FIG. 4 is a schematic view of the structure of the pneumatic tire of FIG. 1; and.

FIGS. 5 and 6 are two different schematic and lateral views of the pneumatic tire of FIG. 1.

### PREFERRED EMBODIMENTS OF THE INVENTION

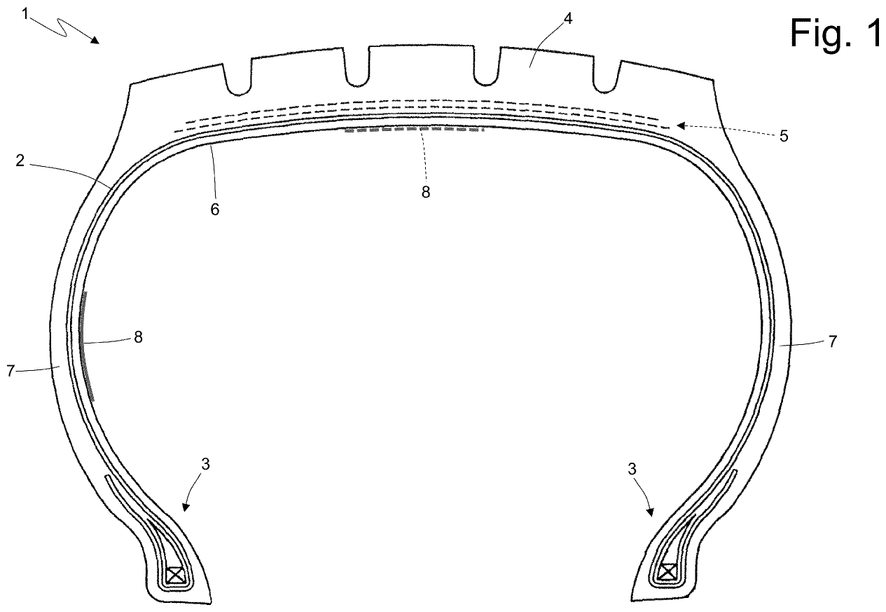

In FIG. 1, reference numeral 1 indicates as a whole a pneumatic tire 1 comprising a toroidal carcass 2, which is partially folded onto itself and therefore has two lateral flaps (i.e., two layers superimposed on one another and jointly referred to as a “turn-up”). Two annular beads 3 are provided at opposite sides of the carcass 2, wherein each thereof is surrounded by the carcass 2. The carcass 2 supports an annular tread 4 with the interposition of a tread belt 5. Arranged within the carcass 2 is an innerliner 6 which is airtight, constitutes an inner lining and has the function of retaining the air within the tire 1 in order to maintain the inflation pressure of the same tire 1 over time. The carcass 2 supports a couple of lateral walls 7, each of which links a bead 3 to the tread 4.

The pneumatic tire 1 is provided with an RFID (“Radio-Frequency IDentification”) label 8, also called a “smart label,” which is capable of memorizing information and/or acquiring signals related to the operating conditions or the state of the pneumatic tire 1 and is capable of communicating via radio frequency. In other words, the RFID label 8 is configured to respond to the remote polling on the part of suitable fixed or portable apparatuses, called readers (or else, interrogators) or autonomously transmitting signals to a receiver; a reader or a receiver is capable of reading and/or modifying the information contained in the RFID label 8, communicating in radio frequency.

According to the illustration of FIG. 1, the RFID label 8 is arranged on a lateral wall 7 of the pneumatic tire 1; according to other embodiments illustrated with dashed lines in FIG. 1, the RFID label 8 could be arranged on components of the pneumatic tire 1 other than the lateral walls 7, such as the tread 4.

According to the illustration in FIG. 1, the RFID label 8 is glued on the innerliner 6, i.e., it is applied to the inner surface of the pneumatic tire 1, which is constituted by the innerliner 6 (therefore, the RFID label 6 is in direct contact with the innerliner 6). In other words, the RFID label 8 is outside of the pneumatic tire 1, i.e., it is not integrated within the pneumatic tire 1 and it is applied (fixed, affixed) to a radially inner surface of the innerliner 6, i.e., on a surface of the innerliner 6 which is outside the pneumatic tire 1 and therefore is in direct contact with the air within the pneumatic tire 1 and therefore on the innermost free surface of the pneumatic tire 1. According to different embodiment (not shown), the RFID label 8 is integrated in the interior of the pneumatic tire 1, i.e., it is inserted between the components of the pneumatic tire 1 during the construction of the pneumatic tire 1 itself (for example, the RFID label 8 could be arranged between the carcass 2 and the innerliner 6 or between the carcass 2 and a sidewall 7).

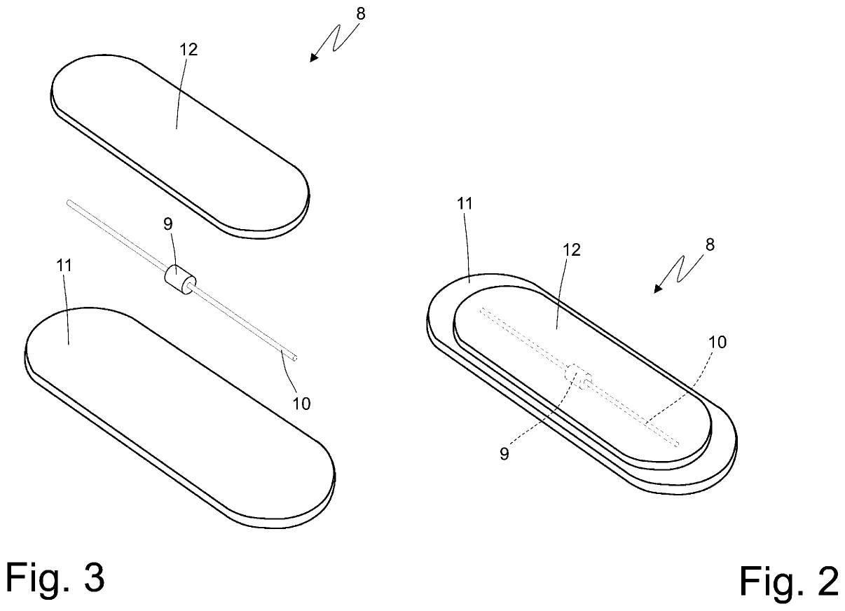

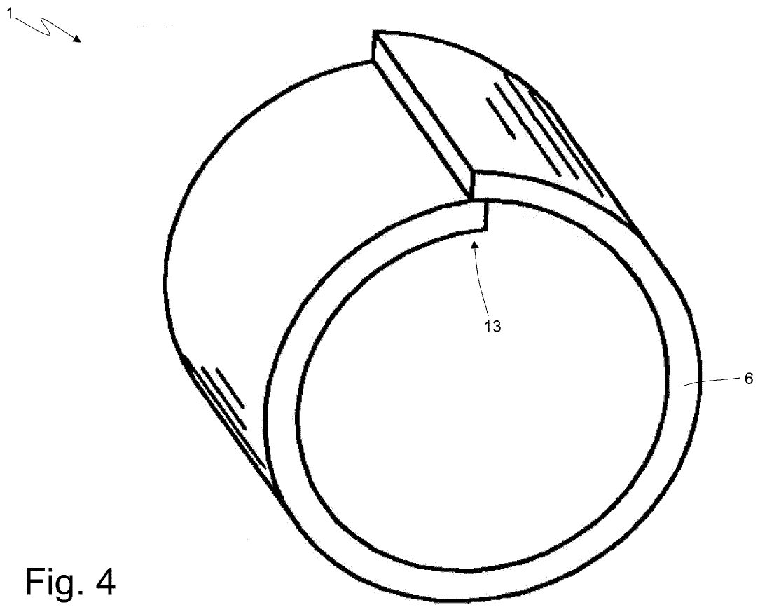

According to the illustrations of FIGS. 2 and 3, the RFID label 8 comprises an electronic circuit 9 (i.e., a microchip) provided with a non-volatile memory and an antenna 10 connected to the electronic circuit 9 (preferably the electronic circuit 9 and the antenna 10 constitute a transponder, i.e., the RFID label 8 is substantially a transponder); these components are inserted in a rubber enclosure made up of two strips 11 and 12 of rubber that are overlapped and pressed one onto the other.

The green components (carcass 2, tread belt 5, tread 4, innerliner 6 . . . ) of the pneumatic tire 1 overlap one another to form a flat strip which is then wrapped (around, i.e., over an assembly drum of a construction machine) to form a cylinder, which is then deformed in order to assume the final toroidal shape. In particular, the strip, being wrapped in a ring, is connected onto itself, forming a plurality of joints (each component of the pneumatic tire 1 is joined in a different position in order to avoid overlapping of the joints and therefore to avoid forming a great discontinuity at a single point). Among the various joints within the pneumatic tire 1 and according to the illustration of FIG. 4, a joint 13 of the innerliner 6 is present; i.e., the innerliner 6 of the green pneumatic tire 1 has a joint 13 in which the two opposing flaps of the innerliner 6 are joined to one another (by means of a slight overlap). The green pneumatic tire 1 is then subjected to a vulcanization process in a suitable vulcanization mold.

The joint 13 confers a cylindrical shape to the innerliner 6 of the pneumatic tire 1 and is axially oriented, i.e., it is parallel to the central axis of the pneumatic tire 1 around which the pneumatic tire 1 rotates during use.

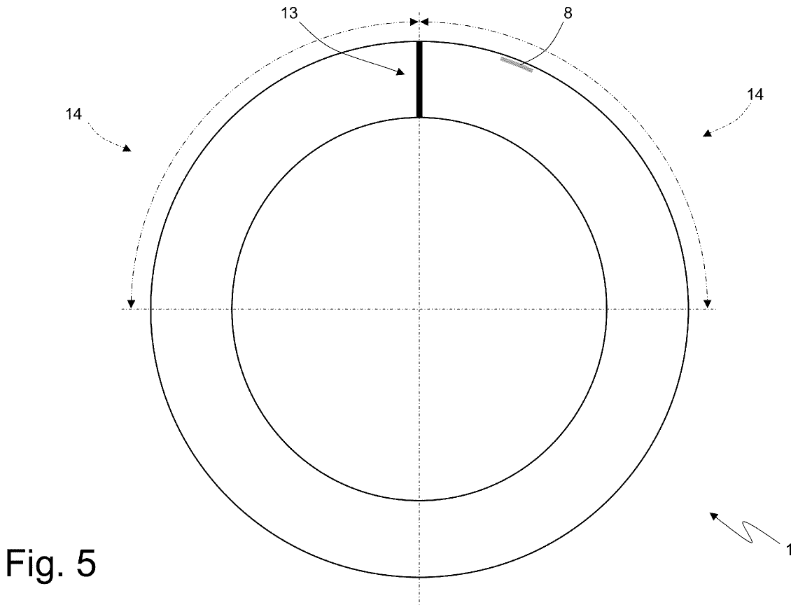

According to the illustration of FIG. 5, the RFID label 8 is internally arranged in a zone 14 which is centered on the joint 13 (i.e., the joint 13 is arranged exactly at the center of the zone 14) and extends circumferentially, starting from the joint 13, for no more than 90° per side (i.e., the maximum extension of the zone 14 is 90° per side). In other words, the zone 14 has a maximum circumferential extension of 180° (therefore covers at most exactly half of the pneumatic tire 1). According to an alternative embodiment, the zone 14 has a maximum circumferential extension of 150°, 120° or 90°; i.e., the zone 14 extends circumferentially, starting from the joint 13, for no more than 75°, 60° or 45° per side.

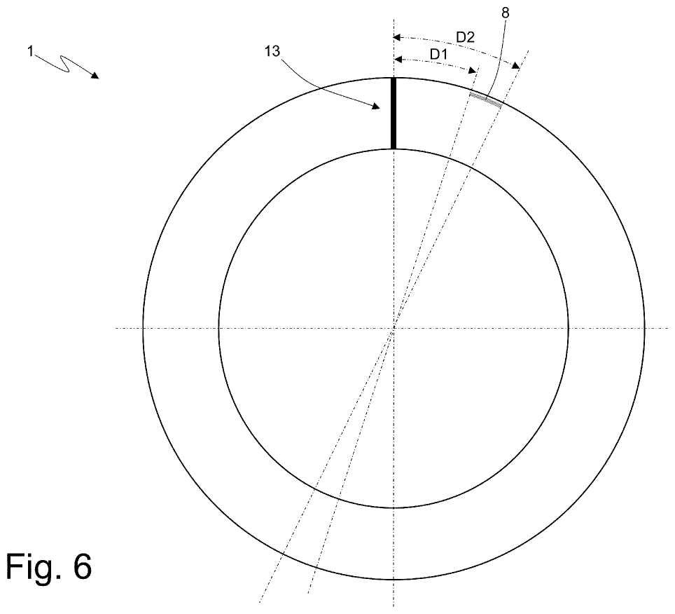

According to the illustration of FIG. 5, the RFID label 8 is preferably not overlapping the joint 13, i.e., (as better illustrated in FIG. 6) the RFID label 8 is arranged at a non-zero circumferential distance D1 from the joint 13.

More generally and according to what is better illustrated in FIG. 6, a proximal end of the RFID label 8 is arranged at the circumferential distance D1 from the joint 13 that is greater than 0° and at a distal end of the RFID label 8 (circumferentially opposite the proximal end) is arranged at a circumferential distance D2 from the joint 13 (greater than the circumferential distance D1) which is less than 90° (i.e., less than 75°, 60° or 45°). Obviously, the circumferential distance D2 is greater than the circumferential distance D1, because the circumferential extension of the RFID label 8 is included between the two circumferential distances D1 and D2.

Before initiating the vulcanization process, a release agent (i.e., a lubricating liquid) is applied (sprayed) inside the pneumatic tire 1 and has the purpose of preventing the adhesion (vulcanization) of the rubber of the innerliner 6 to the air chamber which is inflated within the pneumatic tire 1 in order to apply the necessary mechanical pressure. After the process of application (spraying) of the release agent, as a general rule the green pneumatic tires 1 to be vulcanized (i.e., ready to be vulcanized) should be arranged in a rack with a vertical orientation in which they may remain for a certain time (or even different times or several days). When the green pneumatic tires 1 (to be vulcanized) are “parked” in the rack, the joint 13 is carefully arranged up high (i.e., at the highest point), that is, each pneumatic tire 1 is oriented (turned) in such a way that the joint 13 is located at the top; the purpose of this orientation is that the release agent dripping by gravity does not accumulate near the joint 13 and instead accumulates in a zone of the pneumatic tire 1 far from the joint 13 (and in general also from other joints). In fact, if the release agent were to accumulate or in any case were to flow copiously near the joint 13, it could end up penetrating into some micro-fissures of the joint 13, causing a premature formation of detachments or cracks of the innerliner 6 that in the short term would cause the indispensable impermeability of the pneumatic tire 1 to be lost.

In the same way, if the release agent were to accumulate or in any case were to flow copiously near the RFID label 8, it could end up penetrating into the RFID label 8 and the innerliner 6, causing a premature formation of detachments or cracks of the innerliner 6 that in the short term would cause the indispensable impermeability of the pneumatic tire 1 to be lost. Therefore, keeping the RFID label 8 in the zone 14 prevents the release agent from accumulating or in any case flowing copiously near the RFID label 8 and, as a result, prevents the potential formation of cracks (ruptures) in the innerliner 6 (i.e., prevents the rupture of the innerliner 6 due to the infiltration of release agent).

In the embodiment illustrated in the attached figures and described above, an RFID label 8 is applied to the radially inner surface of the innerliner 6 (which constitutes the innermost free surface of the pneumatic tire 1); according to other embodiments (not shown), an electronic device different from the RFID label 8, for example an electronic device which constitutes a TMS (“Tire Mounted Sensor”) or is a part of a TMS is applied to the radially inner surface of the innerliner (6) (which constitutes the innermost free surface of the pneumatic tire 1).

The embodiments described herein may be combined without departing from the scope of protection of the present invention.

The pneumatic tire 1 described above has many advantages.

In the first place, the pneumatic tire 1 described above has a minor defect of the innerliner 6 at the RFID label 8; this result is obtained by avoiding an accumulation of release agent near the RFID label 8 before the vulcanization process.

Furthermore, the pneumatic tire 1 described above is of a particularly simple and economical implementation, because it does not require any additive components, just a focus (easily automatable) on the positioning of the RFID label 8.

### LIST OF REFERENCE NUMBERS IN THE FIGURES

1 tire
2 carcass
3 beads
4 tread
5 tread belt
6 innerliner
7 sidewalls
8 RFID label
9 electronic circuit
10 antenna
11 rubber strip
12 rubber strip
13 joint
14 zone
D1 circumferential distance
D2 circumferential distance

1-15. (canceled)

16. A pneumatic tire comprising:
an innerliner which constitutes an inner covering and is configured to hold air inside the pneumatic tire;
a joint of the innerliner configured to confer a cylindrical form to the innerliner; and
an electronic device which is applied to a radially inner surface of the innerliner which constitutes an innermost free surface of the pneumatic tire;
wherein the electronic device is internally arranged in a zone which is centered on the joint and extends circumferentially, starting from the joint, for no more than 90° per side.

17. The pneumatic tire of claim 16, wherein the electronic device comprises a radio frequency identification (RFID) label.

18. The pneumatic tire of claim 16, wherein the zone in which the electronic device is arranged has a maximum circumferential extension of 180°.

19. The pneumatic tire of claim 16, wherein the zone in which the electronic device is arranged has a maximum circumferential extension of 150°, 120° or 90°.

20. The pneumatic tire of claim 16, wherein the electronic device is not overlapped at the joint.

21. The pneumatic tire of claim 16, wherein the electronic device is arranged at a first non-zero circumferential distance from the joint.

22. The pneumatic tire of claim 16, wherein a distal end of the electronic device is arranged at a second circumferential distance from the joint which is less than 90°.

23. The pneumatic tire of claim 22, wherein a proximal end of the electronic device circumferentially opposite the distal end is arranged at a first non-zero circumferential distance from the joint.

24. The pneumatic tire of claim 16, wherein a proximal end of the electronic device is arranged at a first circumferential distance from the joint which is greater than 0°, and a distal end of the electronic device circumferentially opposite the proximal end is arranged at a second circumferential distance from the joint which is less than 90°.

25. A method of production of a pneumatic tire, the method comprising:
creating an innerliner which constitutes an inner covering and is configured to hold air inside the pneumatic tire;
folding the innerliner in a ring to form a joint, configured to confer a cylindrical shape to the innerliner, around an assembly drum of a construction machine; and
applying an electronic device to a radially inner surface of the innerliner which constitutes the innermost free surface of the pneumatic tire, wherein the electronic device is arranged entirely in a zone which is centered on the joint and extends circumferentially, starting from the joint, for no more than 90° per side.

26. The method of claim 25, wherein the electronic device is a radio frequency identification (RFID) label.

27. The method of claim 25, further comprising:
applying a release agent to the pneumatic tire while green for a subsequent vulcanization process; and
storing the green pneumatic tire after the application of the release agent and before the vulcanization process, with a vertical orientation in which the joint is located at a highest point.

28. The method of claim 25, wherein the zone in which the electronic device is arranged has a maximum circumferential extension of 150°, 120° or 90°.

29. The method of claim 25, wherein the zone in which the electronic device is arranged has a maximum circumferential extension of 180°.

30. The method of claim 25, wherein the electronic device is not overlapped at the joint.

31. The method of claim 25, wherein the electronic device is arranged at a first non-zero circumferential distance from the joint.

32. The method of claim 25, wherein a distal end of the electronic device is arranged at a second circumferential distance from the joint which is less than 90°.

33. The method of claim 25, wherein a proximal end of the electronic device is arranged at a first circumferential distance from the joint which is greater than 0°, and a distal end of the electronic device circumferentially opposite the proximal end is arranged at a second circumferential distance from the joint which is less than 90°.
